(19) United States
(12) Patent Application Publication
(10) Pub. No.: US 2010/0057842 A1
(43) Pub. Date: Mar. 4, 2010

(54) DISPLAY PULLOUT

(75) Inventors: Siegbert Priller, Weihenstephan (DE); Peter Eckert, Kroening (DE); Stefan Gramelsberger, Eichendorf-Aufhausen (DE); Christian Schiessleder, Reisbach-Haberskirchen (DE)

Correspondence Address: HARNESS, DICKEY & PIERCE, P.L.C., P.O. BOX 828, BLOOMFIELD HILLS, MI, 48303, US

(73) Assignee: Knuerr AG, Arnstorf (DE)

(21) Appl. No.: 12/528,272

(22) PCT Filed: Mar. 27, 2007
(86) PCT No.: PCT/EP07/02702

§ 371 Date: Aug. 21, 2009

(30) Foreign Application Priority Data
Feb. 22, 2007 (DE) 20 2007 002 614.5

(51) Int. Cl. G06F 13/00; G06F 15/16; G06F 21/00; G06F 3/048

(52) U.S. Cl. 709/203; 710/316; 726/16; 715/764

(57) ABSTRACT

The invention relates to a display pullout for electronics or information technology cabinets, which can be effectively utilized in modern communication technology environments. The display pullout has at least one display and at least one input interface, which can be transferred from a space-saving storage position in the cabinet into a working position for operating the input interface and/or data output on the display. A computing unit having at least one processor, a volatile memory and a device for the graphical output of data on the flat display is provided in the rear region of the display pullout, and is configured for the determination and processing of information and/or data of a majority of the input via the input interface and for the output of the information and/or data determined on the display for communication with at least one server.

The invention relates to a display pullout for electronics or information technology cabinets according to the preamble of claim 1.

Such display pullouts are also referred to as TFT drawers. They comprise at least one essentially flat display and at least one input interface. It is hereby provided that the at least one display and the at least one input interface can be transferred from a space-saving storage position in a cabinet into a working position in particular projecting out of the cabinet for operating the at least one interface and/or data output on the at least one display. For example a keyboard, mouse or other input interfaces may be provided as an input interface.

These display pullouts are used for example in 19″ electronics cabinets and are used as an input and output interface for computers or servers provided in this electronics cabinet. Such a TFT drawer is known for example from DE 20 2006 000 313 U1.

Furthermore a similar display pullout is described for example in U.S. Pat. No. 4,019,963 B2 and U.S. Pat. No. 6,807,054 B1. In these cases, however, a further complete PC component is additionally provided on the display pullout. This serves then for communication via a network and enables a user to have the same functions as on a desktop PC. However, the two display pullouts described here are very poor or only provide a limited facility in relation to input and output of data on the servers which are located in the same 19″ rack.

On the other hand modern server administration tools are often no longer dependent upon a direct input and output on the server itself and instead provide corresponding interfaces for example in the form of web applications. There is thus no necessity for a direct input and output possibility on the server.

Although, as explained, a direct connection to a server is no longer necessary for normal administrative purposes, direct access is in particular often required in critical situations, for example in case of partial hardware failure.

A further problem in the use of a PC in such display pullouts is that these have a relatively high probability of failure in comparison with the servers used. They also require a very large amount of space in such a display pullout, meaning that only relatively small components can be used. The heat additionally produced by the active components of a further PC must not be overlooked in the overall heat situation of a server rack as these components often already work at their thermal boundaries.

It is an object of the invention to create a display pullout for electronic or information technology cabinets which can be used effectively in modern communications environments.

This object is achieved according to the invention by a display pullout with the features of claim 1.

According to this it is provided that a computing unit is incorporated in the rear region of the display pullout. Said computing unit comprises at least a processor, a volatile memory and a device for the graphical output of data on the flat screen of the display pullout. Furthermore the computing unit is configured for the determination and processing of the information input via the input interface in such a way that it sends this information and data to a central server. This central server then sends the information back to the computing unit which then outputs it on the display. Corresponding communication devices are provided for this both on the server and on the computing unit.

Further advantageous embodiments are indicated in the dependent claims, the description, the drawings and the description of the drawings.

A core idea of the invention can be seen in that the display pullout according to the invention allows an intermediate stage to be created between a pure display pullout without further information processing units and the known display pullouts with provided PCs. It is hereby possible to connect the advantages of the version without a PC with the advantages of the TFT drawers with PCs. In contrast with conventional TFT drawers, the user is provided according to the invention with a ‘slimmed-down’ version of a computer. It is hereby possible to access a server which provides corresponding interfaces through corresponding networks or possibly direct connections. Examples for such interfaces are the known web interfaces for configuration of mail servers, firewalls or gateways.

On the other hand the display pullout according to the invention does not comprise a complete PC, whereby firstly less heat is produced. Secondly, in principle fewer parts are used and the probability of failure is thus lower. A further advantage of the construction according to the invention is that by using fewer components less space is also used and therefore other, additional devices may possibly be integrated into the display pullout.

According to a preferred embodiment the computing unit is configured so that it can carry out applications on the at least one server. This server can either be housed in the same rack or also at any other desired position which is connected to the computing unit via an information network. However, the server can also be any desired information system. It has proved advantageous if the server is configured as a terminal server. It is hereby possible for the computing unit itself to be equipped with extremely low processor capacities. The actual processing of the information is then realised on the terminal server. The computing unit sends a keyboard input on the display pullout via a network or another information connection to the terminal server, on which the input is then processed and a corresponding result is sent back to the computing unit. The computing unit then displays this result on its connected display. The individual mouse and/or keyboard input is thus transmitted for example to the terminal server and the result or the reaction is sent back to the computing unit for output on the display.

In principle any desired configuration can be used as a computing unit. It is particularly advantageous, however, if the computing unit is configured as a thin or fat client. This client itself often has no operating system of its own and has instead only a very slimmed-down Bios variant which upon starting loads an operating system from a central server. As a result the majority of the maintenance work on the client or the computing unit itself becomes superfluous. If a plurality of such display pullouts are used in a data centre it is not necessary in case of changes in the configuration for each display pullout or the corresponding computing unit itself to be newly set up. Instead, a central setting on the terminal server would suffice.

In principle, however, it is also conceivable for the clients themselves to have a mini operating system which is stored for example on a flashcard. The remaining operating system would then be subsequently loaded via a network for example with TFTP protocol. Of course, the whole operating system and further applications can also be subsequently loaded via the network. The same advantage applies with the applications used which are installed on the terminal server or are also executed there. It is thus not necessary to provide corresponding applications on each client.

Within a further preferred embodiment a switching device is provided in a display pullout in addition to the computing unit. By means of this switching device the optional connection of the input and output interfaces of the display pullout to the computing unit or at least a computing device not arranged in the display pullout is possible. These computing devices may for example be a server arranged in the information technology cabinet or a KVM switch. The advantages of conventional technology in that only a KVM-switch-like device is provided are thus connected with the new devices in which merely a PC is used. It is thus possible to switch as desired between the “operating system” on the computing unit itself and a direct input and output on the servers. Should the computing unit no longer function, direct communication with the servers is still possible. By providing such a switching device in the display pullout itself space is saved in the electronics cabinet, meaning that other servers can be incorporated and thus the cost framework of such a cabinet is improved.

According to a preferred embodiment the display comprises a device for user identification and/or verification. This can be provided for example in the form of a card reader. It has hereby proved advantageous to arrange said card reader on the front side of the opened display. In principle, however, other identification and verification devices are also possible, for example in the form of a fingerprint scanner. When using such an identification and/or verification device there are the advantages that for example the identification can be carried out throughout the system. This leads to a user who identifies himself with a corresponding chip card on the display pullout having the same user rights which he has in the whole system. If a thin or fat client is used as a computing unit it can also be provided that the user has the same work environment available to him as at his other work stations. In addition there are further advantages in relation to an increased system security as through the combined identification and verification access to the central servers by unauthorised parties is at least made more difficult.

In principle the communication of the computing unit with the central server can be configured in any way desired. It is advantageous, however, if corresponding communication connections, in particular network connections, are provided on the rear side of the display pullout. Communication with the server can hereby be carried out via a network, for example a network on a copper basis or in larger server centres also on an optical waveguide basis. No additional communication devices are thus required and instead the networks existing in a server area or data centre can be used. Access to the display pullout from a distance via this network is hereby also possible. The network itself can be operated on an IP basis.

In order to reduce the probability of failure of the display pullout with the computing unit it has proved advantageous to equip the computing unit with non-mobile and/or non-volatile memories. By excluding mobile storage media, for example common hard disks, mechanical movements are excluded, whereby the failure rate is reduced. In this connection for example flashcards or other non-volatile memories can be used. The device can have in particular a rear USB port for memory sticks or external drives.

In order to allow advantageous arrangement of the display pullout according to the invention it has as a maximum the height of a height unit and a width of 19″, meaning that it can be incorporated into common computer, information technology or server cabinets. For example telescopic rails can be provided for installation so that it can be easily moved into the work position. It is particularly advantageous for such a display pullout to be incorporated into an electronics or information technology cabinet and to thus use it for management and administration of servers arranged in this cabinet. By using a computing unit, however, it can also be used to communicate directly with more remote servers.

The invention is explained in greater detail below by reference to an embodiment and schematic illustrations. The drawings show:

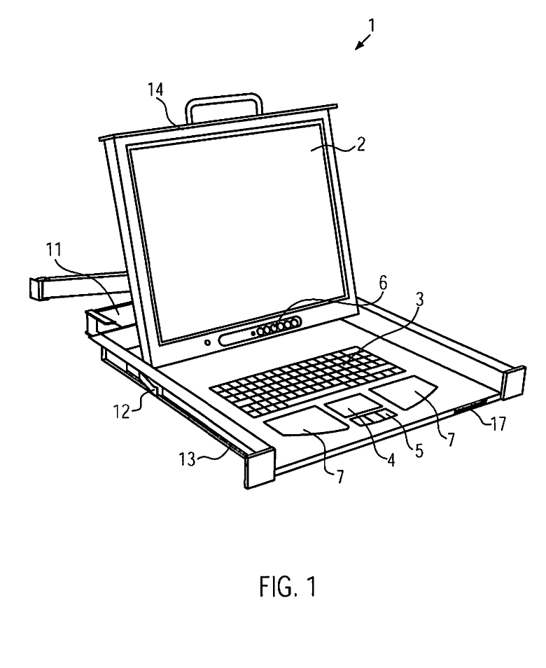

FIG. 1 a view inclined from the front of a display pullout with a folded up display;

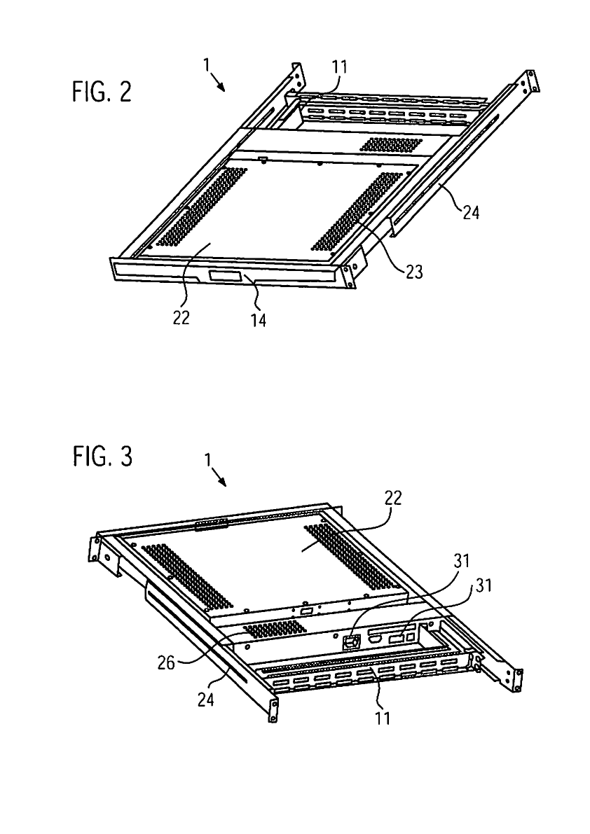

FIG. 2 a view inclined from the front of a display pullout with folded down display;

FIG. 3 a view inclined from the rear of a display pullout with folded down display; and

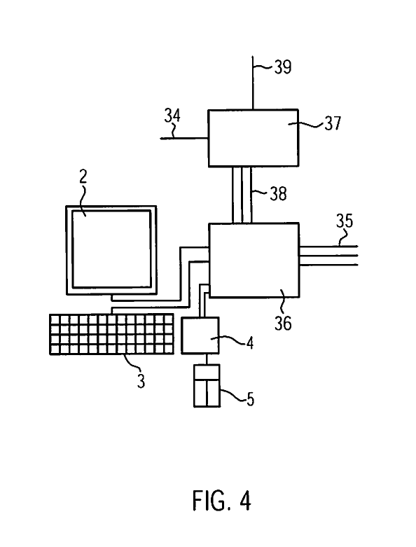

FIG. 4 a schematic view of the display pullout with a thin client 37 and KVM switch 36.

FIG. 1 shows a display pullout with folded up display 2. This display 2 can for example be configured in the form of a TFT screen or also an LCD screen. Function keys 6 are disposed on the lower edge of the display 2. Various functions may be assigned to said function keys. For example it is hereby possible to carry out adjustments in relation to the brightness, the contrast or similar on the screen 2. However, there is also the possibility of switching the input media 3, 4, 5 and the display 2 to another outlet of a KVM switch 36 (not shown) in the rear region of the display pullout 1.

A keyboard 3 is arranged in front of the display 2. Said keyboard 3 is as far as possible flat so that the display pullout 1 has a small height in the folded-together state. A touchpad 4 is provided in this illustration in the same plane in which the keyboard 3 is located. Said touchpad 4 additionally comprises further mouse function keys 5. In order to allow best possible ergonomic design of the input for the user, hand rests 7 are found to the left and to the right of the touchpad 4, which hand rests 7 can for example be made of foam rubber. Although it cannot be seen from this illustration, a card reader 17 can be arranged on the front side of the display 2, i.e. on the side facing the user, which card reader 17 allows user identification and verification to be carried out via a card and a corresponding PIN input. It is thus possible for the user to work with his account adapted specially to him. Through the identification the thin client 37 located in the rear region of the display pullout 1 connects to a central terminal server and provides the user with his own work environment adapted to him. The assignment of rights is hereby also carried out adapted to the user so that unauthorised parties can possibly log into the computer but cannot obtain relevant data there and cannot carry out any security-critical functions.

In order to fold up the display a panel 14 is provided on the top of the display which comprises a corresponding grip.

Rails 13 are provided on the side of the display pullout 1 which have a spring device 12. The display pullout 1 can be pulled out of the server cabinet on these rails. The spring device 12 serves to fix the display pullout in the pulled-out position, also referred to as the work position, in such a way that it cannot roll back unintentionally. A cable guide 11 can also be seen here in the rear region. This serves to receive the cables and to guide them so that no jamming of the cables can arise when the display pullout 1 is pulled out or pushed back in again.

FIGS. 2 and 3 each show a view of a display pullout 1 in the closed state. The cable guide 11 is in turn shown here. The support rails 24 which are connected to the rails 13 are provided on the side of the rails here. Said support rails 24 are incorporated into the server cabinet itself. The rails 13 slide thereon on rollers or similar sliding means so that as little resistance as possible must be overcome upon pulling out and pushing in the display pullout 1. The display pullout 1 shown here has a different front panel 14 from that shown in FIG. 1. The display 2 is hereby folded down onto the keyboard 3 so that only its display cover 22 is visible on the rear side. In order to remove the heat produced by the display this rear side 22 comprises corresponding ventilation openings.

The display pullout shown in FIG. 2 is shown inclined from the rear in FIG. 3. The various connections 31 are hereby visible. These are designed for the supply of power or for connection to other computing units. The power supply can hereby be designed with an integrated universal power supply which can work with voltages of 100V to 240V. The connection with corresponding network components is also provided. The ventilation holes of the computer or computer unit 26 are located on the left side of the display pullout 1. Below is a thin client 37 which is directly connected to the display 2 and the input interfaces 3, 4 and 5. There is a KVM switch 36 on the right region which is hidden by the cover. The thin client 37 is directly connected to the KVM switch 36. This KVM switch 36 is connected to the display and the input interfaces 3, 4 and 5. In addition a connection is provided on the rear side for connection to a plurality of other servers. It is possible using the function keys 6 shown in FIG. 1 to switch the KVM switch 36 so that the thin client 37 is connected to the display and the input media or also to another server. The corresponding keys can of course also be provided at other locations.

FIG. 4 shows a schematic view of the switching of the display 2, the keyboard 3, a KVM switch 36 and a thin client 37. The display 2 and the keyboard 3 by way of example for different types of possible input and output interfaces are connected to the KVM switch 36. This connection is arranged internally in the display pullout 1. The KVM switch 36 has a plurality of user-end further connections 38 and 35. The KVM switch 36 can for example hereby be connected via the connections 35 to external servers, other external computing units or external KVM switches. The connections 38 are guided internally to a thin client 37 also arranged in the display pullout 1. Said thin client 37 is connected via a connection 39 to an information network, so that it can communicate with a remote terminal server. An external USB connection 34 can for example also be provided. In addition there are further user-end connections 35 on the KVM switch 36. These may lead for example to other servers located in the same rack as the display pullout 1. Through corresponding switching the display 2 and the keyboard 3 are directly connected to one of these servers so that it has the same effect for the user as if he were directly in front of the server and could access it with an input and output interface.

It is accordingly possible with the display pullout according to the invention to provide a construction which can be incorporated into information technology and server cabinets and is optimised in relation to the modern server administration and management.

1. Display pullout for electronics or information technology cabinets,
with at least one, essentially flat display,
with at least one input interface,
wherein the at least one display and the at least one input interface can be transferred from a space-saving storage position in the cabinet into a work position in particular projecting from the cabinet for operating the at least one input interface and/or a data output on the at least one display, and
with at least one processor,
wherein
a computing unit with a volatile memory and a device for graphical output of data on the flat display is provided in the rear region of the display pullout, wherein the processor is provided in the computing unit and in that the computing unit is configured for the determination, editing and/or processing of information and/or data of a majority of the input via the input interface and for the output of the determined information and/or data on the display for communication with at least one server via an information network.

2. Display pullout according to claim 1,
wherein
the computing unit is configured to carry out applications on the at least one server.

3. Display pullout according to claim 1,
wherein
the computing unit is constructed for communication with at least one terminal server.

4. Display pullout according to claim 1,
wherein
the computing unit is designed as a thin client or fat client.

5. Display pullout according to claim 1,
wherein
a switching device is provided for optional connection of the at least one display and the at least one input interface with computing devices not arranged in the display pullout.

6. Display pullout according to claim 1,
wherein
a device for user identification and/or verification is provided.

7. Display pullout according to claim 1,
wherein
a card reader is provided which is arranged in particular on the front side of the display.

8. Display pullout according to claim 1,
wherein
connections for communication connections, in particular network connections, to the at least one server are provided in the rear region.

9. Display pullout according to claim 1,
wherein
the computing unit is configured for communication via a, in particular TCP/IP based, network.

10. Display pullout according to claim 1,
wherein
the computing unit is equipped with a non-mobile, in particular non-volatile memory.

11. Display pullout according to claim 1,
wherein
a height of maximum one height unit and a width of maximum 19″.

12. Electronics or information technology cabinet with a display pullout according to claim 1.
